(19) United States
(12) Patent Application Publication
(10) Pub. No.: US 2013/0253981 A1
(43) Pub. Date: Sep. 26, 2013

(54) PROVIDING MARKETING ANALYTICS RELATED TO A SALES OPPORTUNITY OVER A TIMELINE IN A MARKETING MANAGEMENT SYSTEM

(71) Applicants: Glen Lipka, San Mateo, CA (US); Pavel Kramer, South San Francisco, CA (US); Shuanhu Wang, Mountain View, CA (US)

(72) Inventors: Glen Lipka, San Mateo, CA (US); Pavel Kramer, South San Francisco, CA (US); Shuanhu Wang, Mountain View, CA (US)

(73) Assignee: Marketo, Inc., San Mateo, CA (US)

(21) Appl. No.: 13/426,389

(22) Filed: Mar. 21, 2012

(51) Int. Cl. G06Q 30/02

(52) U.S. Cl. 705/7.29

(57) ABSTRACT

A marketing management system interfaces with a sales platform, company servers, and various other sources of data to obtain information about leads, contacts, interactions, events, and opportunities. The system provides a user interface that displays marketing events (i.e., interactions with various leads in an account) in a temporal context along with opportunity creation and/or close, together with filtering capabilities to display/hide activities associated with various leads. This enables visualization of the relationship between an individual opportunity and all the activities that are linked to the leads related to the opportunity, thus allowing comparison of marketing events to sales activities facilitating understanding of how to attribute marketing contributions to sales revenue. The interface may allow for assignment of leads to opportunities based on the level of interaction between the marketing/sales staff and the lead.

### BACKGROUND

This invention relates generally to marketing systems, and in particular to providing marketing analytics related to a sales opportunity and associated lead interactions over a timeline in a marketing management system.

In recent years, sales and marketing departments have migrated to automated marketing/sales platforms to track entities such as leads, opportunities, and accounts, as well as interactions that are associated with these entities. A lead is a person, sometimes representing a company, who may have interests in a firm's products or services. A marketing department receives new leads (names) through website visits, or marketing campaigns such as pay per click (PPC), tradeshows, and road shows, etc. After a lead is received by the marketing department, it is nurtured so that it could develop into an opportunity—people or companies with genuine buying intent in the near future. Actions taken to nurture and develop the lead include marketing emails, phone calls, invitations for leads to webinars or road shows, etc. Once marketing decides that there is a potential for the lead to buy the firm's products or services in the near future, the lead is sent to the sales department, where the lead is followed up to determine whether there is a genuine intent to purchase. An opportunity is created when such intent exists. Sales representatives will then work on the opportunity and try to close the deal. An account usually refers to a company, which could have multiple leads that are captured by the firm's marketing system. An account could also have many sales opportunities, including an initial sales opportunity, an upsell/cross-selling opportunity, and the like.

Interactions associated with the lead entities include aforementioned marketing actions, as well as actions taken by sales staff—i.e., sales emails, phone calls, online meeting, demos, customer visits, to name just a few. They also include activities such as web visits, which are originated by the leads, both before and after the leads reach the opportunity status. Because a lead is frequently attached to accounts, especially in enterprise sales, interactions are likely associated with accounts. Similarly, they could be associated with opportunities.

Even a medium-sized company could get millions of leads through different marketing channels. The management of this large body of leads—to keep track of them, to identify the potential customers to nurture, to identify the high-quality ones as opportunities, among other activities—is extremely time-consuming and difficult. To keep track of all the interactions and associations between them and the opportunities is even more challenging.

Existing marketing/sales systems do not track how an individual sales opportunity may have been developed into a conversion from one or more leads. Keeping track of hundreds of thousands, or even millions of leads and the individual actions taken with each of those leads to understand how marketing spend influenced those leads that led to a sales opportunity is not feasible for most marketing departments. An individual sales opportunity may take months to develop, often interacted with by different staff members. Even if they were to record that information, organizing such information to track individual sales, and to present it in a meaningful way, would be a huge burden with limited resources. However, this information would be valuable to a marketing executives looking to show a return on investment on the marketing budget in terms of tangible sales data. Without them, senior management have to justify marketing spending based on aggregated marketing budget and aggregated sales.

Specifically, marketing/sales departments do not have an effective tool to gather and organize information about what marketing/sales interactions may have influenced an individual sales opportunity. An efficient mechanism is needed to measure the effectiveness of marketing/sales interactions on producing sales revenue. As a result, marketing spend may be allocated more efficiently through highly targeted marketing campaigns, generating additional sales revenue. However, existing analytics systems have not provided users with tools or methods of providing this valuable information relating marketing/sales interactions with individual sales opportunities.

### SUMMARY

A marketing management system interfaces with a sales platform, company servers, and various other sources of data to obtain information about leads, contacts, interactions, events, and opportunities. The system provides a user interface that displays marketing activities (i.e., interactions with various leads in an account) in a temporal context along with opportunity creation and/or close, together with filtering capabilities to display/hide activities that are associated with various leads. This enables visualization of the relationship between an individual opportunity and all the activities that are linked to the leads related to the opportunity, thus allowing comparison of marketing activities to sales activities and facilitating understanding of how to attribute marketing contributions to sales revenue. The interface may allow for assignment of leads to opportunities based on the level of interaction between the marketing/sales staff and the lead.

### BRIEF DESCRIPTION OF THE DRAWINGS

FIG. 1 is high level block diagram illustrating a process of providing marketing analytics related to a sales opportunity over a timeline in a marketing management system, in accordance with an embodiment of the invention.

FIG. 2 is a network diagram of a system for providing marketing analytics related to a sales opportunity over a timeline in a marketing management system, showing a block diagram of the marketing management system, in accordance with an embodiment of the invention.

FIG. 3 is high level block diagram illustrating a marketing analytics presentation module that includes various modules for providing marketing analytics to users of a marketing management system, in accordance with an embodiment of the invention.

FIG. 4 is a flowchart of a process of providing marketing analytics data related to a sales opportunity over a timeline in a marketing management system, in accordance with an embodiment of the invention.

FIGS. 5A-G are examples of a user interface for providing marketing analytics related to a sales opportunity over a timeline in a marketing management system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A marketing management system provides its users with the ability to collect and organize information about marketing activity conducted to produce sales opportunities. Frequently, such a system is also able to take input from a variety of sources, including a sales platform, a company's systems, and other data sources. In a marketing management system, an opportunity may be defined as a record in a database system indicating a point in time when a sales representative may start to interact with a potential customer. Marketers may conduct numerous activities to generate leads—people that could become opportunities—for sales representatives to contact and close sales opportunities, including producing whitepapers, distributing online web content, attending trade shows, conducting webinars to demonstrate a product, and following up with prospective customers. Once leads have been generated and nurtured into potential sales opportunities, meaning that customers' needs have been identified, sales representatives follow up to verify whether there is a genuine buying intent. If such intent exists, a sales opportunity is created and sales representatives will then try to close the opportunities. Each opportunity may eventually be closed by a sales representative as “won” or “lost,” meaning that a sales transaction was or was not successful. Historically, marketers have been unable to attribute their marketing efforts to an individual sales opportunity, relying instead on aggregated information about sales revenue and marketing spend to justify their spending budget.

The marketing management system may gather interactions with leads performed by marketing staff and sales representatives from an external sales platform, a company's systems, and other data sources, such as spreadsheets, databases, and other records that have been created over time. Interactions with leads, organized by account and by opportunity, may be plotted along a timeline by the marketing management system, such as an indication of heavy web traffic by a lead on the company's website, an indication that a lead signed up for a webinar, an email from marketing staff opened by the lead following up on a webinar signup, an indication that the lead downloaded a whitepaper about a product, an interaction recorded by a sales platform that a sales representative contacted the lead, an indication of the lead being converted into an opportunity, and an indication of the closing the sale on the opportunity. As a result, marketing staff may analyze the impact of marketing activities on the revenue cycle at an individual opportunity level.

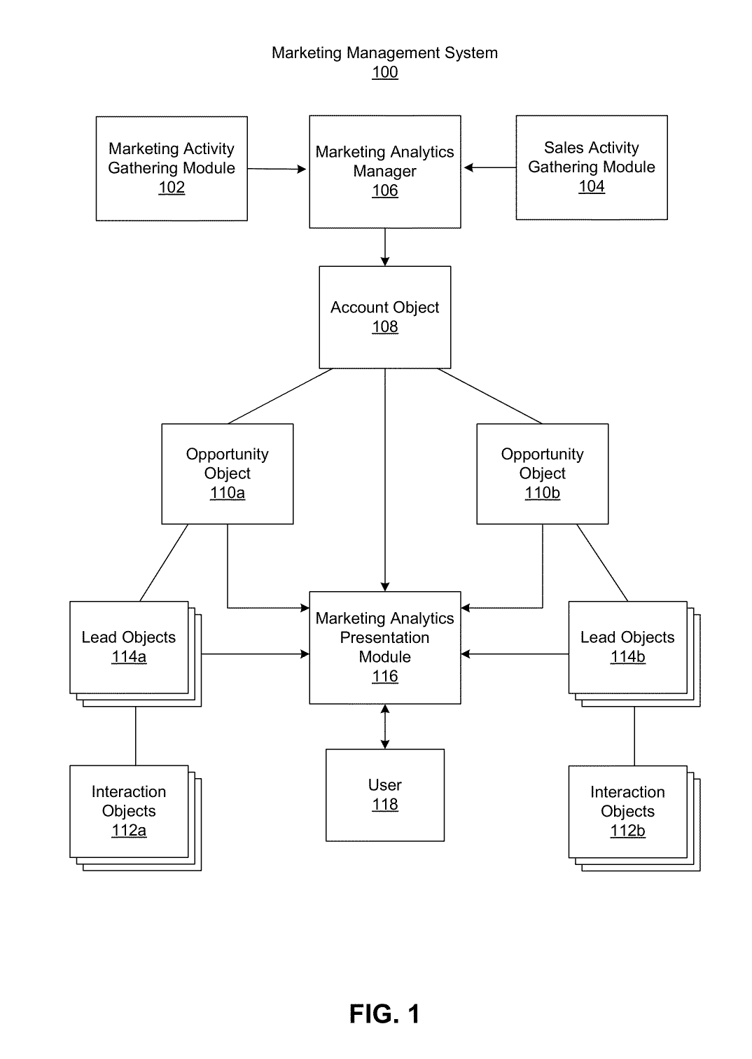

FIG. 1 illustrates a high level block diagram of a process for providing marketing analytics related to a sales opportunity over a timeline in a marketing management system, in one embodiment. The marketing management system 100 includes a marketing activity gathering module 102 and a sales activity gathering module 104 that gathers information about interactions with leads associated with opportunities for a particular account. The marketing management system 100 also includes a marketing analytics manager 106 that receives the information about interactions with leads associated with opportunities for a particular account and generates an account object 108 associated with a plurality of opportunity objects 110.

FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” and/or “110b” in the figures). Only two opportunity objects 110 are shown in FIG. 1 in order to simplify and clarify the description.

The marketing management system 100 may associate an interaction object 112 with a lead object 114 based on the content of the interaction. For example, heavy web traffic by a lead associated with a lead object 114 may be associated with an interaction object 112. As another example, an indication that an email was opened by the lead associated with the lead object 114 may be associated with another interaction object 112. In this way, the lead objects 114 have been associated with interaction objects 112.

To attribute marketing activity to a newly created opportunity, represented by an opportunity object 110, marketing staff may use the marketing management system 100 to create the opportunity object 110, in one embodiment, and associate it with the account object 108. When creating the opportunity object 110, at least one lead associated with a lead object 114 must be identified as having a role in the opportunity represented by the opportunity object 110. Once the lead associated with the lead object 114 is associated with an opportunity object 110, the associated interaction objects 112 are also associated with the opportunity object 110. In another embodiment, marketing staff may use the marketing management system 100 to access the opportunity object 110 and associate it with the account object 108. The marketing management system 100 may be connected to an external sales platform and/or external company system. By associating the opportunity object 110 to the account object 108, the marketing management system 100 may integrate the opportunity object 110 and account object 108 into the marketing management system 100 via the external sales platform and/or external company system. In one embodiment, marketing staff may select leads associated with lead object 114 to be associated with an opportunity object 110 in a user interface provided by the marketing management system 100. In another embodiment, a lead object 114 is automatically associated with an opportunity object 110 upon creation. Lead objects 114 may be created through a user interface provided by the marketing management system 100 and inputted by marketing staff or through application programming interface (API) calls with an external sales platform or the company's system. In a further embodiment, marketing staff may import a list of leads into the marketing management system 100, such as a Microsoft Excel spreadsheet or comma separated value file. Lists of leads may be purchased through external vendors, for example.

As illustrated in FIG. 1, opportunity objects 110 are provided to a marketing analytics presentation module 116 for presentation to a user 118 of the marketing management system 100. The marketing analytics presentation module 116 may present interaction objects 112a that are associated with lead objects 114a that are associated with an opportunity object 110a that is associated with an account object 108. The user 118 may access the opportunity object 110b associated with the account object 108 through the marketing analytics presentation module 116 to view interaction objects 112b associated with lead objects 114b that are associated with the opportunity object 110b. When an opportunity associated with an opportunity object 110 closes, based on information received from the sales platform, the amount of the sale may be attributed to the interaction objects 112 associated with the opportunity object 110. In one embodiment, the interaction objects 112 may include detail information, such as the date of the interaction, cost of the marketing activity, text associated with the interaction, and the lead object 114 associated with the interaction. As a result, the marketing analytics presentation module 116 may present a plotted graph of cumulative interactions over a timeline. In another embodiment, the marketing analytics manager 106 may compute an influence score for each interaction object 112 so that the marketing analytics presentation module 116 may present a plotted graph of the cumulative influence scores of the interaction objects 112 associated with the opportunity over a timeline.

The marketing analytics presentation module 116 may also present lead objects 114 associated with the opportunity in a separate user interface from the plotted graph of cumulative interaction objects 112 over time. In a leads user interface, the marketing analytics presentation module 116 may present the leads associated with the opportunity as well as other leads associated with the account. In the leads user interface, the number of historical interactions may be displayed in conjunction with the names of the leads. The user 118 may select other leads that have not been associated with the opportunity object 110 from the leads user interface to visualize the cumulative interaction objects 112 including interaction objects 112 associated with the selected leads. The user 118 may also indicate that a selected lead in the leads user interface has a role in the opportunity. By selecting additional leads, the plotted graph may be refreshed by the marketing analytics presentation module 116 to include the historical interactions of the additional leads.

Leads are clearly identified in the leads user interface provided by the marketing analytics presentation module 116. Organized by week, a plot point on the plotted graph grows as more interactions occurred during that week on the timeline. The marketing analytics presentation module 116 may also enable the user 118 to click on each plotted point to view a detailed listing of interactions that occurred during that week. As a result, a user 118 viewing the plotted graph may visualize more interactions as the plotted point corresponds to the number of interactions that occurred in that week.

Users of the marketing management system 100 may quickly identify which programs touched the leads and when marketing activity and sales activity began for opportunities for each account. The plotted graph shows the accumulated interactions from the first touch for any lead to the last. As more interactions are accumulated over time, the plotted points are connected with a line. The curve of the line rendered by the marketing management system 100 indicates to a viewer how marketing activities influence an opportunity to create or to close. A higher vertical slope of the line indicates that more interactions occurred in a shorter time period. Once an opportunity is created, an area of the plotted graph under the line to the x-axis may be shaded by the marketing analytics presentation module 116 to indicate the interactions that directly contributed to closing the opportunity. This shaded area provides a visual representation of the interactions performed by marketing staff and sales representatives that lead to a conversion. In another embodiment, the graph illustrates a defined influence of the marketing activities to the opportunity creation where the influence is defined using different weights assigned to different marketing activities.

As a result of using the marketing management system 100, a user 118 may quickly ascertain the owners, channels, and other factors that stimulate opportunity creation and close while also proving marketing's impact on the revenue cycle. This builds credibility by showing how marketing programs drive conversion and accelerate leads through the revenue cycle. Through several user interfaces provided by the marketing analytics presentation module 116, the user 118 may analyze and compare opportunities represented by opportunity objects 110 for a particular account represented by an account object 108 in the marketing management system 100.

### System Architecture

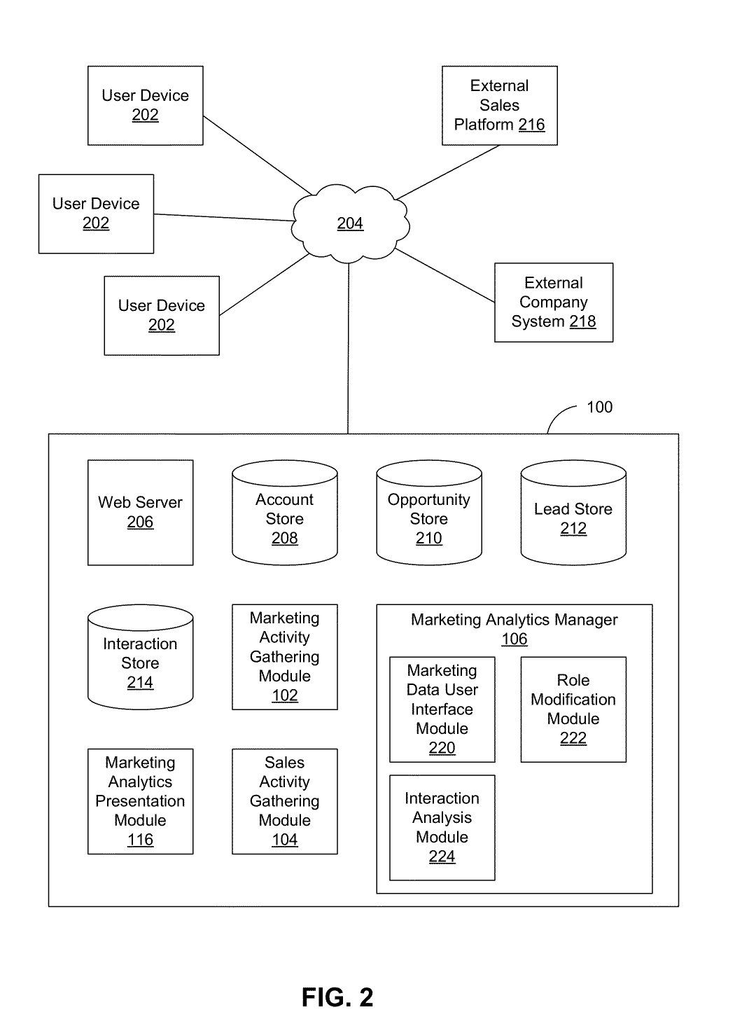

FIG. 2 is a high level block diagram illustrating a system environment suitable for selectively providing content to users of a social networking system, in accordance with an embodiment of the invention. The system environment comprises one or more user devices 202, the marketing management system 100, a network 204, an external sales platform 216, and external company system 218. In alternative configurations, different and/or additional modules can be included in the system.

The user devices 202 comprise one or more computing devices that can receive user input and can transmit and receive data via the network 204. In one embodiment, the user device 202 is a conventional computer system executing, for example, a Microsoft Windows-compatible operating system (OS), Apple OS X, and/or a Linux distribution. In another embodiment, the user device 202 can be a device having computer functionality, such as a personal digital assistant (PDA), mobile telephone, smart-phone, etc. The user device 202 is configured to communicate via network 204. The user device 202 can execute an application, for example, a browser application that allows a user of the user device 202 to interact with the marketing management system 100. In another embodiment, the user device 202 interacts with the marketing management system 100 through an application programming interface (API) that runs on the native operating system of the user device 202, such as iOS and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the marketing management system 100. The marketing management system 100 includes a web server 206, an account store 208, an opportunity store 210, a lead store 212, an interaction store 214, a marketing activity gathering module 102, a sales activity gathering module 104, a marketing analytics presentation module 116, and a marketing analytics manager 106 which comprises a marketing data user interface module 220, a role modification module 222, and an interaction analysis module 224. In other embodiments, the marketing management system 100 may include additional, fewer, or different modules for various applications. Conventional components such as network interfaces, security functions, load balancers, failover servers, management and network operations consoles, and the like are not shown so as to not obscure the details of the system.

The web server 206 links the marketing management system 100 via the network 204 to one or more user devices 202; the web server 206 serves web pages, as well as other web-related content, such as Java, Flash, XML, and so forth. The web server 206 may provide the functionality of receiving and routing messages between the marketing management system 100 and the user devices 202, for example, instant messages, queued messages (e.g., email), text and SMS (short message service) messages, or messages sent using any other suitable messaging technique. The user can send a request to the web server 206 to upload information, for example, images or videos that are stored in the content store 212. Additionally, the web server 206 may provide API functionality to send data directly to native user device operating systems, such as iOS, ANDROID, webOS, and RIM.

A marketing activity gathering module 102 collects information about interactions with leads performed by marketing staff or other users of the marketing management system 100. Such information may include call records to leads, emails directed to leads, indications that emails were opened by leads, indications that emails were viewed but not opened, indications that leads were converted from prospects, indications that leads signed up for webinars, indications that leads downloaded documentation about products, indications that leads were converted into newly created opportunities, opening opportunities, closing opportunities, indications of “interesting moments” such as a lead downloading a whitepaper from the vendor's website, a lead opening an email from a sales representative, a lead attending a webinar, webpage visits, form fill-outs, tradeshows, email interactions, marketing program/campaign successes and so on. This information may be gathered from an external sales platform 216, such as salesforce.com, as well as an external company system 218, such as a customer relationship management (CRM) system offered by Microsoft, Netsuite, or SugarCRM. In one embodiment, the information may be manually inputted into the marketing management system 100 through a user interface. In another embodiment, the information about marketing activity may be gathered by the marketing management system 100 through application programming interface (API) calls to an external company system 218. In a further embodiment, a SOAP (Simple Object Access Protocol) or REST (REpresentation State Transfer) API may be used by the marketing management system 100 to receive an indication that an opportunity has been created.

Similarly, a sales activity gathering module 104 gathers interaction information with leads with sales representatives that has been inputted into an external sales platform 216, recorded in a database on an external company system 218, or manually inputted into the marketing management system 100 through a user interface or through API calls. Sales activity may include indications that leads have been converted into sales opportunities, activity logged by sales representatives regarding closing the opportunities, web activity performed by leads in relation to the opportunities logged by the external company system 218, and information about the outcomes of the opportunities. “Interesting moments” may be manually entered or automatically generated by the marketing management system 100 and included as interactions performed by leads in relation to the opportunity. For example, a lead that visited the website of the product being sold multiple times in a week may trigger an “interesting moment” to be generated by the marketing management system 100. This provides more useful information to the sales representative trying to close the opportunity. Furthermore, the “interesting moment” highlights relevant information that might be otherwise obscured by other information. Such “interesting moments” that may be automatically generated may include a sales email being sent to a lead, a sales email being opened, sales phone calls made, and so on.

These interactions gathered by the marketing activity gathering module 102 and by the sales activity gathering module 104 may be saved as interaction objects 112 stored in the interaction store 214. The interaction objects 112 are also associated with lead objects 114 corresponding to the leads interacted with by marketing staff. These lead objects 114 are stored by the marketing management system 100 in the lead store 212.

A marketing analytics manager 106 receives the information about interactions with leads, including marketing activity gathered by the marketing activity gathering module 102 and sales activity gathered by the sales activity gathering module 104, regarding opportunities for accounts in a marketing management system 100. For example, when a sales representative receives a lead from marketing staff that has been nurtured and developed into a sales opportunity, the sales opportunity is inputted into the marketing management system 100 through a user interface, in one embodiment. In another embodiment, the sales opportunity may be inputted into the marketing management system 100 through an API call from an external company system 218 or through an external sales platform 216 upon identifying the sales opportunity. The marketing analytics manager 106, receiving the information that a lead associated with an account has been nurtured into a sales opportunity, generates an opportunity object 110 associated with an account object 108 in the marketing management system 100 associated with a lead object 114 and an interaction object 112 for the information about the sales opportunity received. Opportunity objects 110 are stored in the opportunity store 210, and account objects 108 are stored in the account store 208 in the marketing management system 100.

The marketing analytics manager 106 includes a marketing data user interface module 220, a role modification module 222, and an interaction analysis module 224. The marketing data user interface module 220 provides a user interface to users of the marketing management module 100 for manually inputting interaction information with leads by marketing staff or sales representatives. The role modification module 222 receives a selection from a user 118 of the marketing management module 100 that indicates a lead associated with a lead object 114 has a role in a sales opportunity represented by an opportunity object 110. The role modification module 222 stores an indication in the lead object 114 associated with the opportunity object 110 that the lead has a role in the sales opportunity. Leads associated with an opportunity may or may not have a role in the sales opportunity. For example, a lead may be a business associate that has done preliminary research about a product being marketed by marketing staff. That business associate may pass along information to a decision maker that may influence the creation and ultimate close of a sales opportunity. The role modification module 222 enables users of a marketing management system 100 to select leads associated with an account to have a role in the creation and/or close of an opportunity.

An interaction analysis module 224 analyzes interactions with leads associated with an opportunity to determine the “interaction score”. In one embodiment, an interaction score may be computed as the number of interactions associated with leads that are associated with the opportunity. In another embodiment, the interaction analysis module 224 determines an interaction score as a weighted average of all the interactions. For example, an indication of a lead opened an email from marketing staff may be weighted, on a scale of 0-100, with a value of 50, as determined by marketing staff. In another embodiment, a regression model may be used to determine the weights based on past interactions and resulting outcomes of sales opportunities. In yet another embodiment, machine learning methods may be used to train a model for determining weights for the different types of interactions. In a further embodiment, the interaction analysis module 224 determines an interaction score using an advanced lead scoring algorithm such that a higher lead score corresponds to a higher interaction score. An advanced lead scoring algorithm provides an instant score of the likelihood that a lead may be interested in a product. An advanced lead scoring algorithm may include a decay factor based on time. Once the advanced lead score reaches a predefined threshold, a marketing person may interpret the lead as having a higher likelihood to become an opportunity, or a sales representative may interpret the advanced lead score as having a higher likelihood of closing the opportunity with the lead successfully.

A marketing analytics presentation module 116 provides information about interactions with leads with respect to an opportunity associated with an account to users of the marketing management system 100. In one embodiment, the marketing analytics presentation module 116 provides a graphical user interface including a graph having an x-axis and a y-axis in which the interactions with leads associated with an opportunity are provided over a timeline as plotted points. Each of the plotted points may appear larger or smaller based on the number of interactions that have occurred during that day or week, depending on how the timeline is provided by the marketing analytics presentation module 116. For example, if there were 3 interactions that occurred with leads associated with an opportunity in the same week, such as an indication that a lead opened an email sent by marketing staff, an indication that the lead also searched for the name of the product being marketed, and an indication that the lead signed up for a webinar about the product, a plotted point would appear larger than a plot point for one interaction happening the next week that includes an indication that a whitepaper was downloaded by the lead about the product. In one embodiment, the number of interactions is cumulative, meaning that a line between the two points in the prior example would have an ascending slope by 1 interaction. The marketing analytics presentation module 116 may also present a separate leads user interface that provides selectable links for the leads associated with the account, including indications that certain leads have been associated with the opportunity being displayed to the user of the marketing management system 100. In the leads user interface, a viewing user of the marketing management system 100 may select and deselect leads to add their historical interactions to the plotted graph, dynamically rendering the plotted points on the graph as leads are selected and deselected.

Providing Marketing Analytics Information for an Opportunity over a Timeline

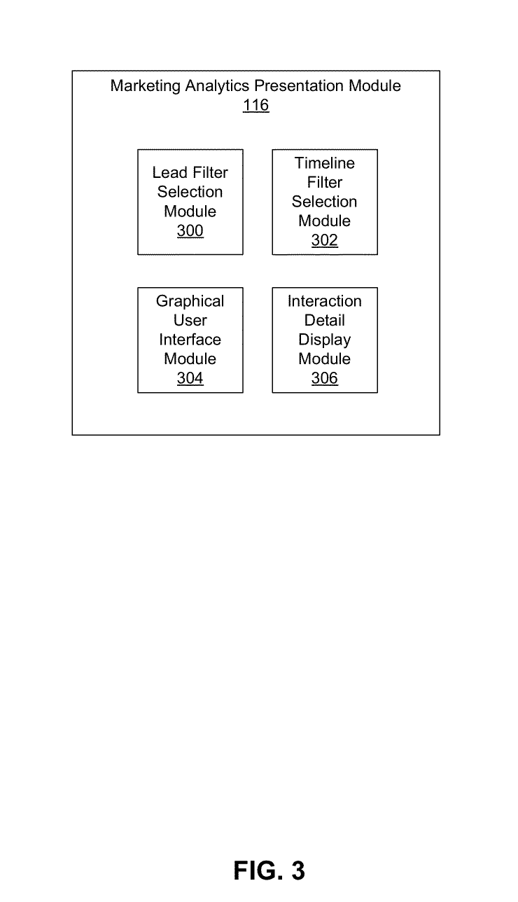

FIG. 3 illustrates a high level block diagram of the marketing analytics presentation module 116 in further detail, in one embodiment. The marketing analytics presentation module 116 provides user interfaces for users of a marketing management system 100 to analyze information about interactions with leads associated with opportunities for accounts. The marketing analytics presentation module 116 includes a lead filter selection module 300, a timeline selection module 302, a graphical user interface module 304, and an interaction detail display module 306. These modules may perform in conjunction with each other or independently to provide a plurality of user interfaces for users of a marketing management system 100 to analyze and understand how marketing activities may contribute to and influence individual sales opportunities.

A lead filter selection module 300 provides leads associated with an account and, for each lead, an indication of whether the lead is associated with the opportunity being viewed by the user of the marketing management system 100. A user may select from a leads user interface, provided by the lead filter selection module 300, an account and an opportunity associated with the account to view interactions associated with the opportunity. Lead objects 114 may be associated with an account object 108 based on being associated with various opportunities represented by opportunity objects 110 on the marketing management system 100. In addition, leads represented by lead objects 114 may be associated with an account object 108 upon being designated as a lead in the marketing management system 100. In this way, the lead filter selection module 300 enables a user to select additional leads that may have contributed to an opportunity that is being viewed by the user of the marketing management system 100. For example, a sales representative may close an opportunity with Joe for $10K. Along with Joe, Bob may also be a lead that is associated with the opportunity. However, upon review of the opportunity object and the interactions associated with leads associated with the opportunity, marketing staff may identify another lead, Mike, that may have contributed to the creation of the opportunity, even if Mike had not been associated with the opportunity. Because Mike was associated with the account, marketing staff would have been provided with a selectable link in a leads user interface by the lead filter selection module 300. In one embodiment, the number of interactions associated with leads may be displayed in the leads user interface to help the user identify other leads and interactions that may have contributed to the opportunity. After selecting links for a lead in the leads user interface, the historical interactions of the selected lead are dynamically displayed in the plotted graph of cumulative interactions.

A timeline filter selection module 302 provides a timeline selection user interface to users of the marketing management module 100 to select a time period during which interactions occurred with leads associated with an opportunity. Using the timeline filter selection module 302, users may select different time periods to view interactions that may have contributed to an opportunity. Users may select a beginning date and an ending date for the timeline that is provided by the marketing analytics presentation module 116. In one embodiment, users may select a date from graphical user interface. In another embodiment, dates may be manually inputted in to the timeline selection user interface provided by the timeline filter selection module 302. After the time period is selected by a user of the marketing management system 100, only interaction objects 112 having dates within the selected time period are provided in the plotted graph of interactions over the timeline. In one embodiment, the marketing analytics presentation module 116 dynamically renders the plotted graph to fit the selected timeline.

A graphical user interface module 304 dynamically renders a plotted graph of interactions over a timeline according to selected filters, including lead filters and timeline filters. In one embodiment, a cumulative total number of interactions is used for the y-axis of the graph and a timeline in months, weeks, or days is used for the x-axis of the graph. In another embodiment, a cumulative interaction score, where an interaction score is determined by the marketing analytics manager 106 for each interaction associated with the opportunity, is used for the y-axis of the graph. The graphical user interface module 304 also generates plotted points based on the number of interactions or the cumulative interaction score of interactions in a given time period, such as a week or a day. The plotted points may be rendered larger or smaller depending on the number of interactions or the cumulative interaction score of interactions. This enables the viewing user of the marketing management system 100 to quickly identify a time period during which multiple interactions with leads associated with the opportunity may have influenced the creation of the opportunity and/or influenced the closing of the opportunity.

The graphical user interface module 304 also renders the plotted graph of interaction points with a line connecting the plotted points, in one embodiment. This visual representation of accumulated interactions associated with an opportunity provides the user of the marketing management system 100 with a quick summary of how the number of interactions with leads associated with an opportunity increased over time. The slope of the rendered line connecting the plotted points provides the user with a visual representation of the number of activities in a given period. For example, a steep line signifies relative periods of high activities, while a flat line, or a line with a lower slope, indicates a lower amount of activities. This information, when combined with other information such as opportunity creation and/or closing date, may indicate a correlation between activities and the success outcome (i.e., creating an opportunity or closing a deal). In another embodiment, the area encapsulated by the plotted line, the x-axis, and vertical lines connecting the x-axis to the interaction point indicating the creation of the opportunity as well as the interaction point indicating the closing of the opportunity may be shaded by the graphical user interface module 304 to enable the viewing user to quickly identify the interactions that led to creating and closing the opportunity. In a further embodiment, where an advanced lead scoring algorithm is used to generate an interaction score to be plotted on the graph, the slope of the line may not have the same significance. Instead, the advanced lead score exceeding a predefined threshold holds more significance to viewers of that graph.

An interaction detail display module 306 provides a detailed description of interactions included in a plotted point on the plotted graph rendered by the graphical user interface module 304. In one embodiment, the interaction detail display module 306 provides a pop-up window that is displayed responsive to a viewing user clicking on one of the plotted points on the rendered graph. The pop-up window includes a detailed listing of the interactions that occurred during that time period, including information about the interactions such as the lead interacted with, a description of the interaction, the type of interaction, whether the interaction was designated as an interesting moment, whether the interaction indicates that an opportunity was created or closed, the amount of the opportunity, textual description inputted by the user creating the interaction, whether the interaction was designated as a milestone, the cost of the interaction (such as the cost of providing a webinar, producing a whitepaper, etc.), and other information that may be useful to a viewing user researching interactions that may have influenced the creation and/or close of an opportunity.

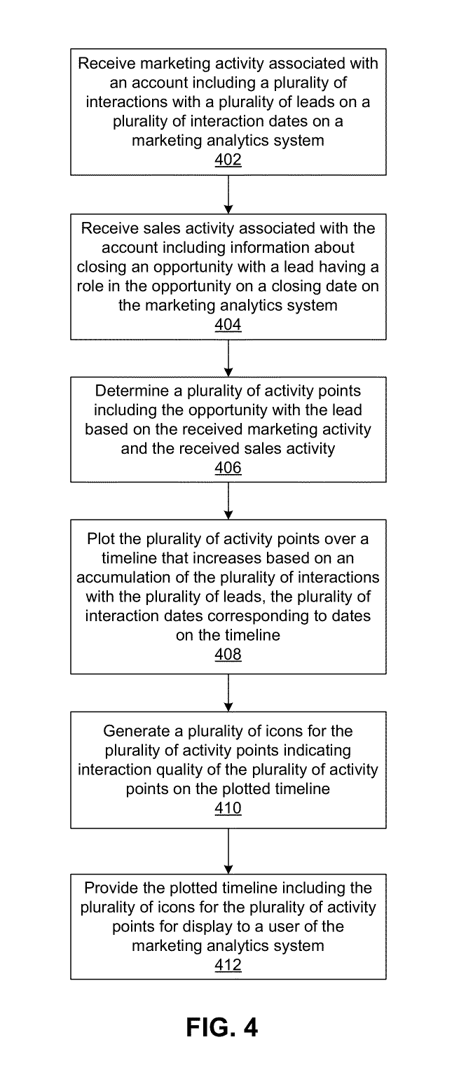

FIG. 4 illustrates a flow chart diagram depicting a process of providing marketing analytics data related to a sales opportunity over a timeline in a marketing management system, in accordance with an embodiment of the invention. Marketing activity associated with an account including a plurality of interactions with a plurality of leads on a plurality of interaction dates is received 402 on a marketing management system. Such marketing activity may include providing webinar signups, sending emails to prospective leads, converting prospects into leads, receiving indications that leads interacted with a website for the product, and the like. This marketing activity may be received 402 by the marketing management system through a user interface, an external company system 218 or an external sales platform 216.

Sales activity associated with the account including information about closing an opportunity with a lead having a role in the opportunity on a closing date on the marketing management system is received 404. In one embodiment, a sales representative using an external sales platform 216 may receive a lead to determine whether an opportunity exists. Using the external sales platform 216, the sales representative may create an opportunity in the marketing management system 100. This creation of the opportunity in the external sales platform 216 is included in the sales activity received 404 by the marketing management system. In another embodiment, sales activity may be received 404 by the marketing management system through an external company system 218. In a further embodiment, sales representatives may manually input sales activity into the marketing management system through a user interface.

A plurality of activity points including the opportunity with the lead is determined 406 based on the received marketing activity and the received sales activity. Activity points may include marketing activity and sales activity performed with leads associated with the opportunity. The marketing activity and sales activity comprise interactions associated with at least one lead associated with the opportunity that may be determined 406 to be included in the plurality of activity points.

After the plurality of activity points are determined 406, the plurality of activity points are plotted 408 over a timeline that increases based on an accumulation of the plurality of interactions with the plurality of leads, in which the plurality of interaction dates correspond to dates on the timeline. The timeline comprises a graph of the plotted plurality of activity points. Each activity point comprises a time period, such as a day or week, and interactions that occurred within that time period. In one embodiment, each activity point is plotted on the timeline according to the accumulated number of interactions associated with the opportunity. For example, if 5 interactions occurred in the first week of January 2012 and 2 interactions occurred in the second week of January 2012, then the activity point for the first week of January 2012 would be at 5 interactions and the activity point for the second week of January 2012 would be 7 interactions, assuming there were no interactions associated with the opportunity before January 2012. In another embodiment, the interaction score for each activity point is plotted 408 over the timeline that accumulates over time. In this way, users of the marketing management system 100 may visually identify the accumulated interactions with leads that ultimately lead to the creation and/or closing of the opportunity.

A plurality of icons for the plurality of activity points indicating interaction quality of the plurality of activity points on the plotted timeline are generated 410. In one embodiment, the plurality of icons may include varying sizes of circles that correlate to the number of interactions that occurred during the time period for each activity point. Returning to the prior example, the icon generated for the first week of January 2012 in which there were 5 interactions recorded by the marketing management system 100 would be larger than the icon generated for the second week of January 2012 in which there were 2 interactions.

In another embodiment, different types of icons may be generated 410 for different types of interactions that occurred during the time period for the activity point. For example, if two (2) of the five (5) interactions that occurred in the first week of January 2012 were interactions related to webinars provided by marketing staff, a presentation icon may be generated 410 for those interactions. Similarly, if one (1) of the interactions that occurred in the first week of January 2012 were interactions related to responding to direct marketing messages from marketing staff, such as follow up emails related to the webinars, indications that the leads opened the emails, and the like, those interactions may be represented by messaging icons generated 410 by the marketing management system 100. Other types of icons that may be generated 410 include icons indicating interesting moments occurred, opportunities were created and/or closed, marketing programs (such as webinars, information sessions, live demonstrations, etc.) were provided by marketing staff, meetings were held with leads attending, communication activity was logged by marketing staff and/or sales representatives (such as phone calls, emails, in person meetings), icons indicating cost of activity, and web activity by leads was recorded by the marketing management system 100 (including web activity such as indications that leads searched for terms related to opportunity, digital downloads of whitepapers, heavy web activity by leads on product websites, and the like), as well as icons indicating opportunity creation and closing in a detailed popup. Program and event successes have additional flags over the chart indicating that these interactions are more important. A viewer may decide what success may be defined as. As a result of the generated 410 icons, users of the marketing management system 100 may quickly see what types of interactions were involved that contributed to the creation and/or closing of the opportunity. The graphical user interface further enables users to label activity points with icons.

The plotted timeline is then provided 412 for display to a user of the marketing management system where the plotted timeline includes the plurality of icons for the plurality of activity points. The plotted timeline may be provided 412 for display to a user of the marketing management system 100 through a web browser operating on a user device 202 communicating with the marketing management system 100. In another embodiment, the plotted timeline may be provided 412 for display in a file format that may be downloaded by the user to the user device 202, such as a Microsoft Excel spreadsheet, a Microsoft Powerpoint presentation slide, or other file format. In yet another embodiment, the plotted timeline may be provided 412 for display to the user of the marketing management system 100 through an application running on a mobile device using application programming interface (API) calls to communicate with the marketing management system 100. In this way, a graphical user interface may be used to provide 412 the plotted timeline for display.

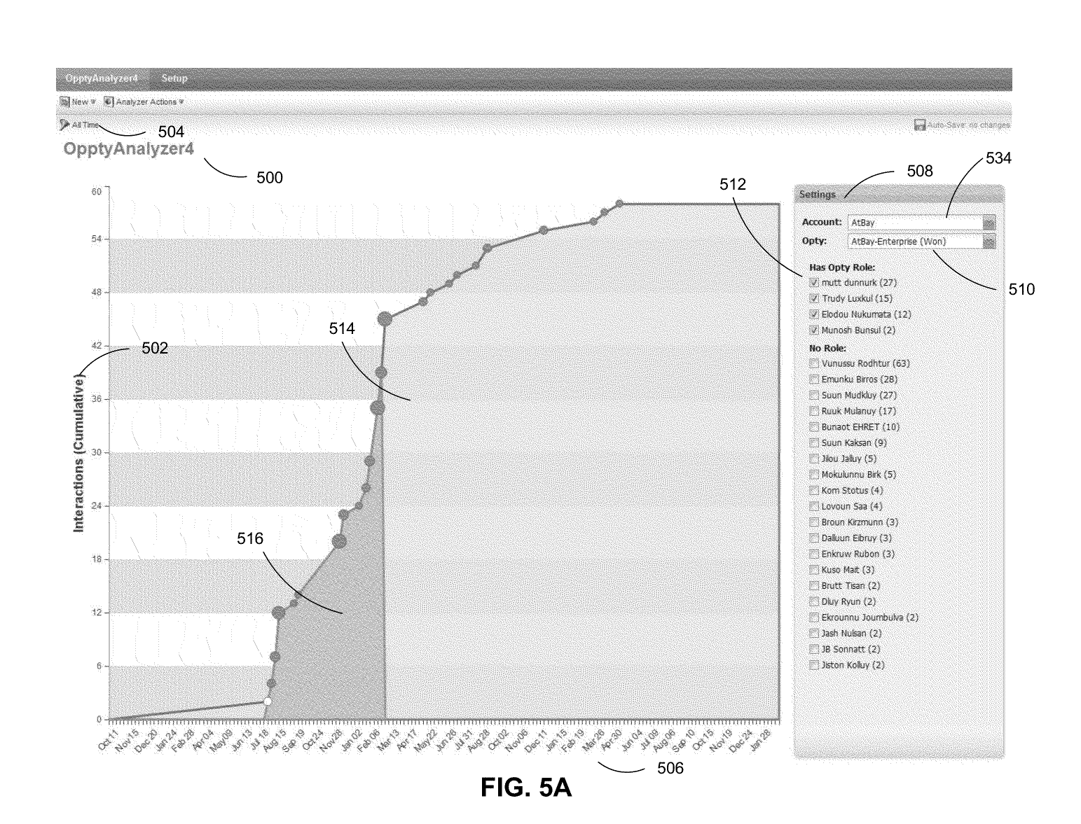

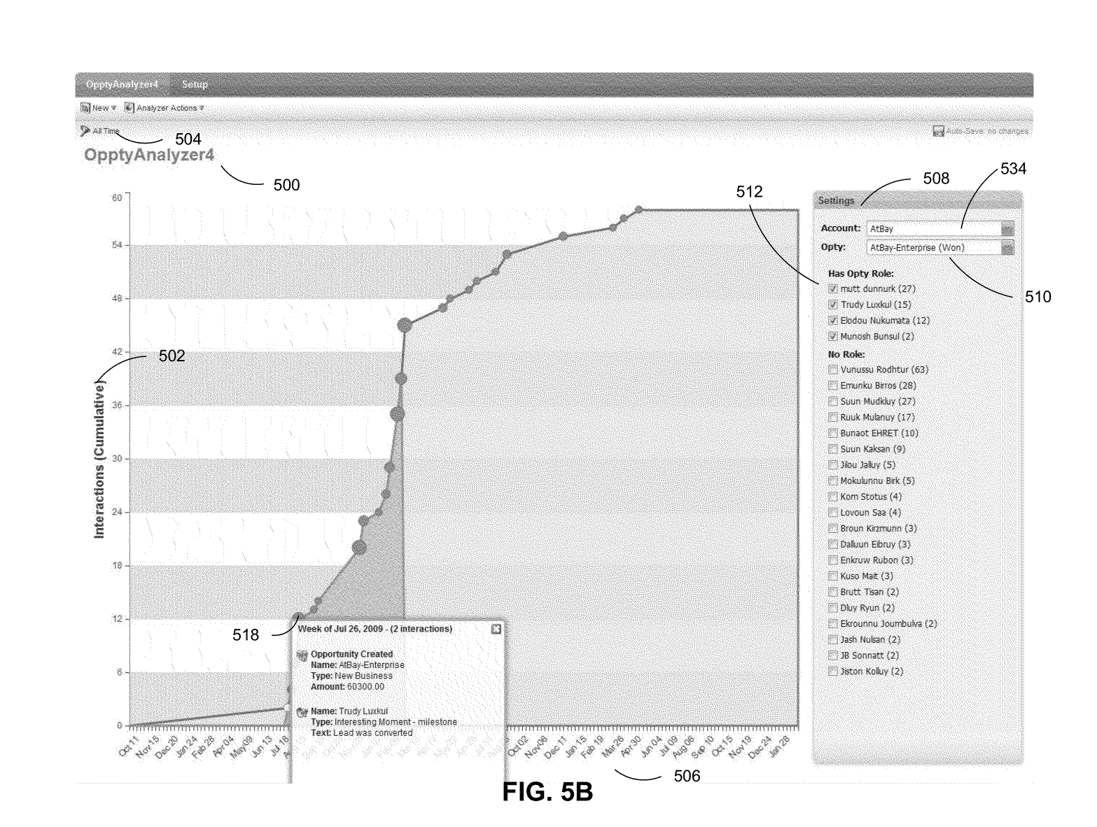

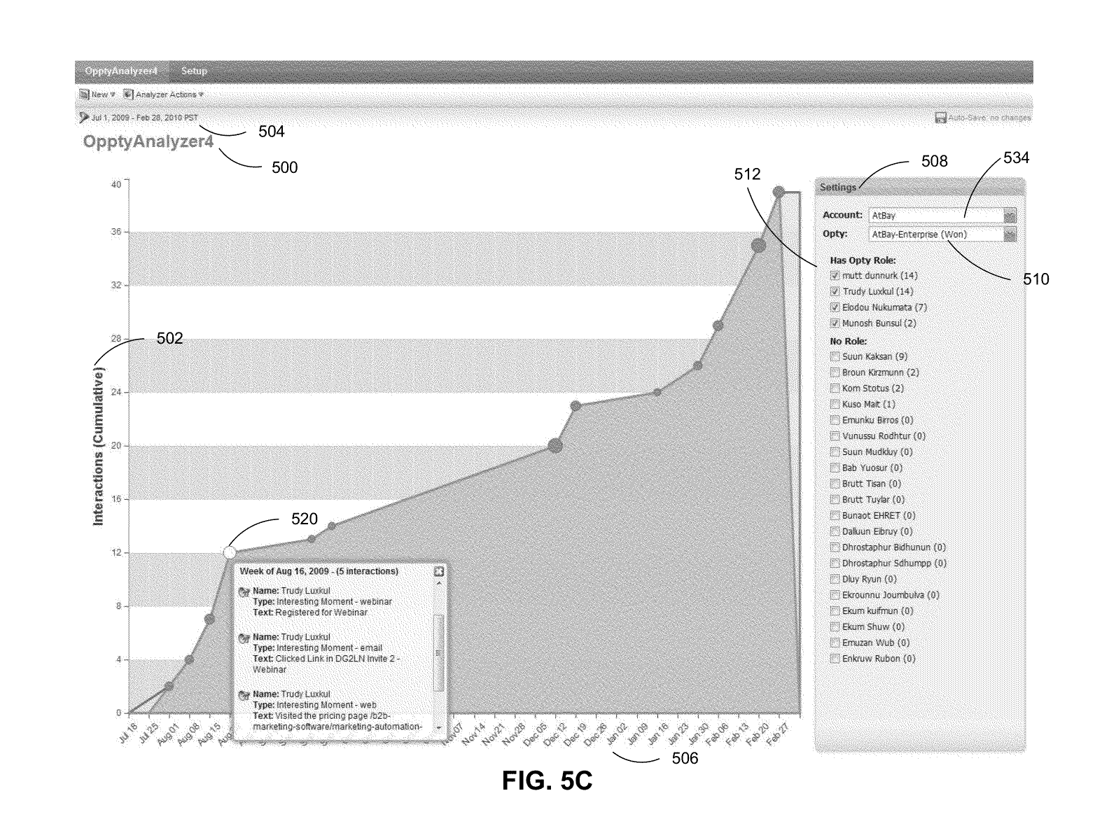

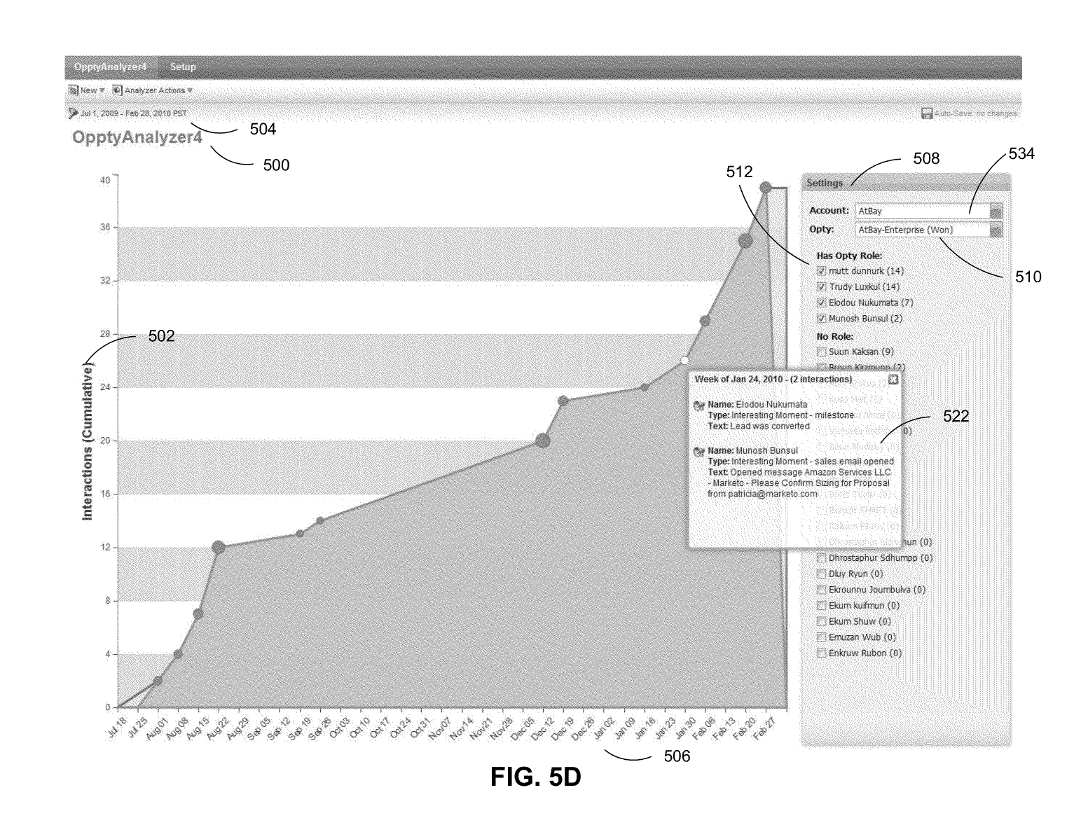

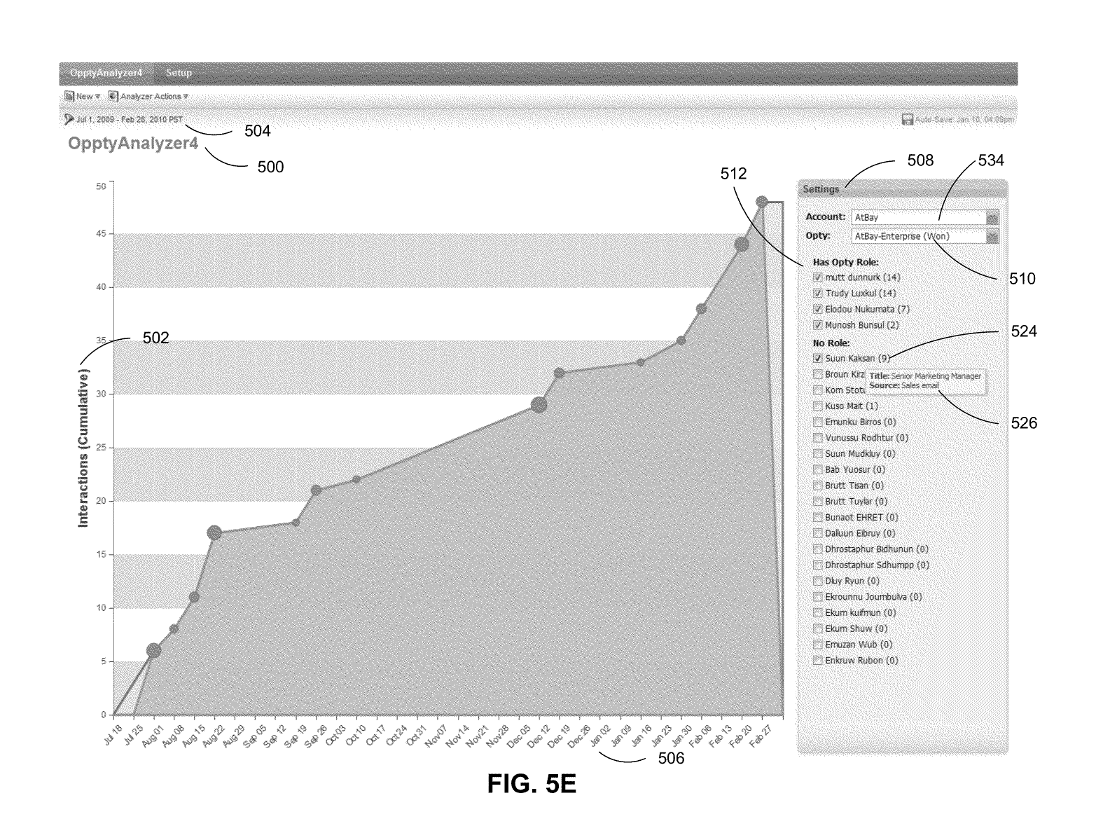

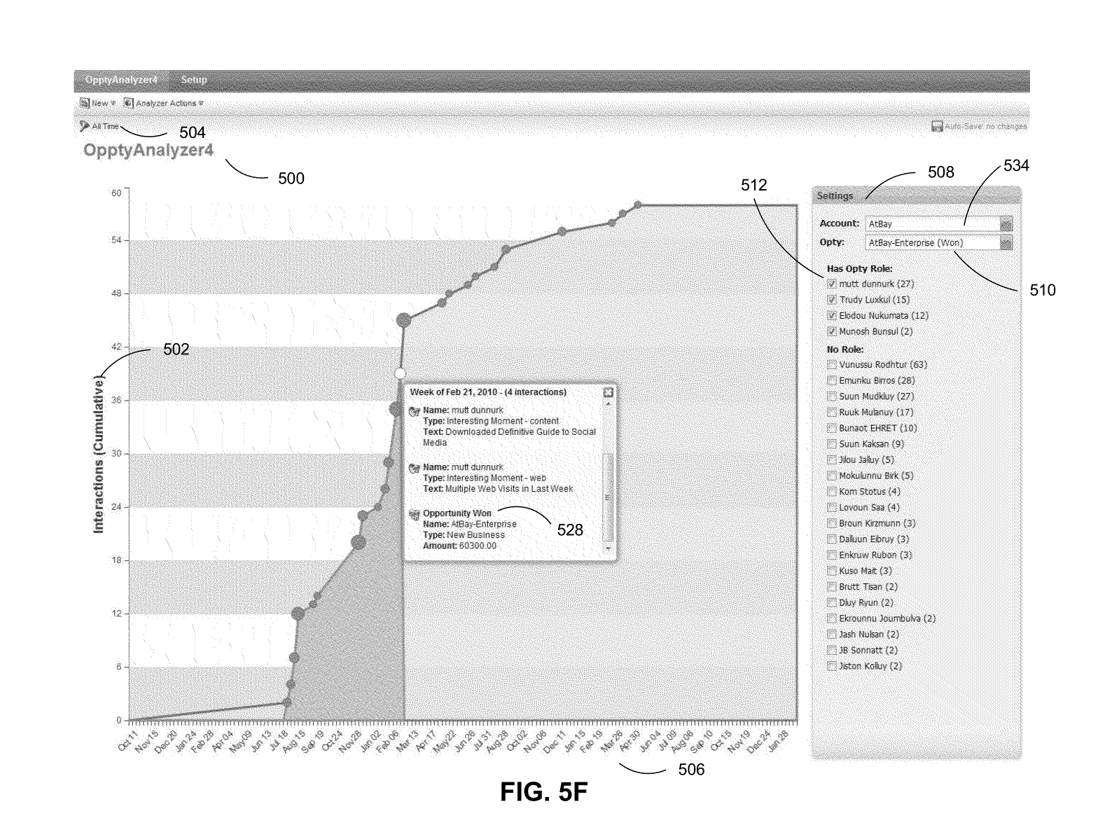

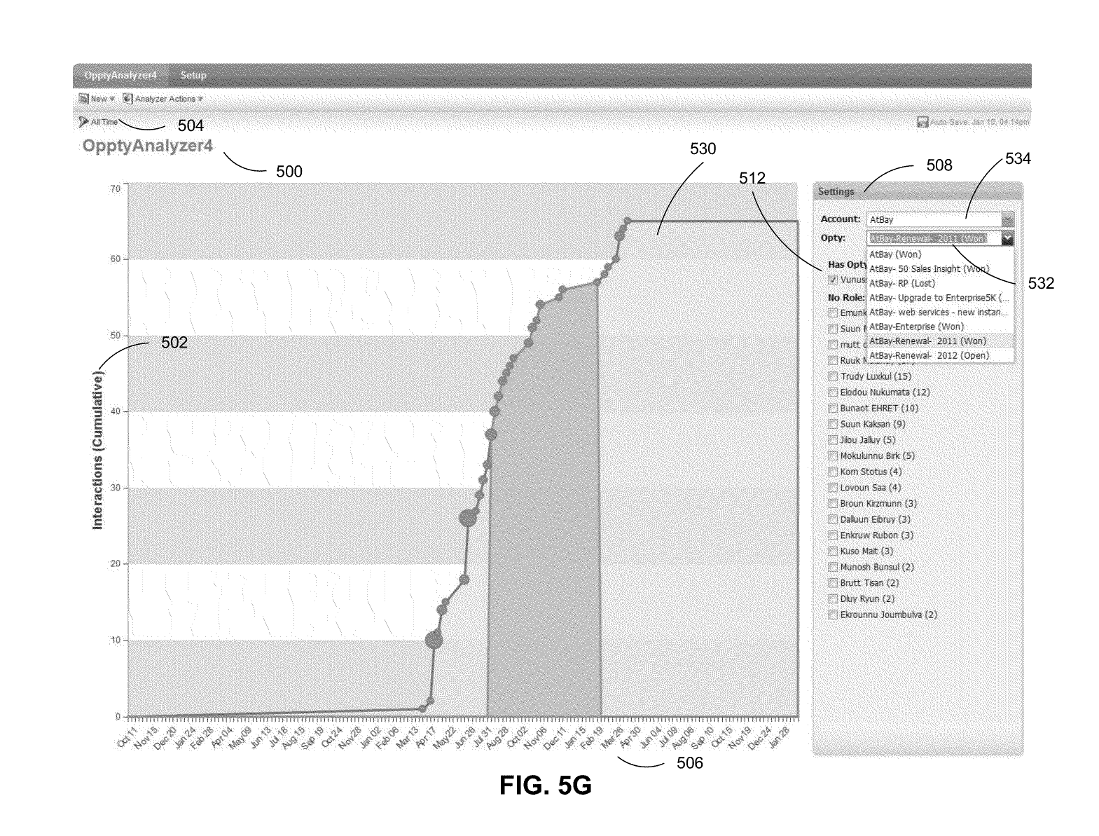

FIGS. 5A-G are examples of a user interface for providing marketing analytics related to a sales opportunity over a timeline in a marketing management system, in accordance with an embodiment of the invention. In FIG. 5A, the user interface provides an opportunity analyzer 500 for viewing interactions associated with an opportunity for an account. The opportunity analyzer 500 includes a plotted graph 514 that has a y-axis 502 that represents cumulative interactions with leads associated with the opportunity and an x-axis 506 that illustrates a timeline based on a selected time period, indicated by the time period interface 504. In FIG. 5A, “All Time” has been selected, meaning that all interactions associated with the opportunity are being viewed in the opportunity analyzer 500.

The opportunity analyzer 500 also includes a leads user interface 508 that includes a drop down menu 534 for selecting accounts, a drop down menu 510 for selecting opportunities associated with the selected account, and a plurality of selectable links 512 representing leads associated with the account that may or may not have a role in the opportunity being viewed. As illustrated in FIG. 5A in the leads user interface 508, four leads have been selected to have roles in the opportunity titled “AtBay-Enterprise” for the “AtBay” account, including “mutt dunnurk,” “Trudy Luxkul,” “Elodou Nukumata,” and “Munosh Bunsul.” From the leads user interface 508, a user of the marketing management system 100 may know that the opportunity has been won because the drop down menu 510 for selecting opportunities indicates that the opportunity has been won. Selection of links in the leads in the leads user interface 508 may be through a click action, a touch action, a gesture action, a voice command, or other user input in the user device. Using the leads user interface 508, opportunities may be viewed individually using the drop down menu 510, and a viewer may switch back and forth between different accounts using the drop down menu 534.

The opportunity analyzer 500 also includes a shaded area on the plotted graph 514 that represents the influence 516 of the interactions on the opportunity being viewed. The shaded area is bounded by the x-axis, a vertical line from the activity point representing an indication that the opportunity was created to the x-axis, a vertical line from the activity point representing an indication that the opportunity was closed to the x-axis, and line segments connecting the activity points between the opportunity creation and closing activity points. From the plotted graph 514, a user of the marketing management system 100 may see that after the opportunity was created around July 18, a sharp increase in interactions were recorded throughout the rest of the summer, but then slowed down starting around September 19. A flurry of interactions occurred after November 28 and continued relatively quickly until the closing around March. Thus, the influence 516 represented by the shaded area on the plotted graph 514 totaled over 40 interactions.

As illustrated in FIG. 5B, the user interface for the opportunity analyzer 500 enables users of the marketing management system 100 to interact with the activity points provided on the plotted graph 514 to view more information about the interactions. In FIG. 5B, an interaction detail pop-up window 518 may be displayed responsive to a selection of an activity point. In the interaction detail pop-up window 518, the opportunity analyzer 500 provides more detailed information about the interactions that occurred during the week of Jul. 26, 2009, including that the opportunity was created and that the lead “Trudy Luxkul” was converted. Other information about the interaction related to indicating that the opportunity was created includes the amount of the opportunity, 60300.00, and the type of opportunity, “New Business.”

As illustrated in FIG. 5C, the timeline selected has been changed from “All Time” to “Jul. 1, 2009-Feb. 28, 2010” as indicated by the time period interface 504. As a result, the opportunity analyzer 500 has adjusted the display of the plotted graph 514 to fill the screen according to the selected timeline. An activity point 520 has been selected to display another interaction detail pop up window for the activity for the week of Aug. 16, 2009 in which 5 interactions occurred. The activity point 520 has been selected and appears highlighted from the other points plotted on the graph 514 by the opportunity analyzer 500.

FIG. 5D illustrates the opportunity analyzer 500 with another interaction detail popup window 522 being displayed, indicating two opportunities that occurred during the week of Jan. 24, 2010. From the interaction detail popup window 522, a viewing user of the marketing management system 100 may see that the lead “Elodou Nukumata” was converted and that the lead “Munosh Bunsul” opened a sales email.

FIG. 5E illustrates the opportunity analyzer 500 after a link 524 associated with an additional lead, “Suun Kaksan” has been selected include the historical interactions associated with that lead to the opportunity analyzer 500. As a result, the number of interactions has increased as displayed by the opportunity analyzer 500. Hovering over the link 524 in the leads user interface 508, a lead detail popup window 526 is displayed to provide more information about the lead.

Information about the closing of the opportunity being viewed on the opportunity analyzer 500 may be viewed in yet another interaction detail popup window 528, as illustrated in FIG. 5F. In that popup window 528, the user may be provided with information that four interactions occurred during the week of Feb. 21, 2010, and the opportunity was won during that week.

In FIG. 5G, another plotted graph 530 may be displayed by the opportunity analyzer 500 after selecting a different opportunity 532 in the opportunity selection drop down menu. That opportunity, labeled “AtBay—Renewal,” may have different leads associated with the opportunity. As shown in FIG. 5G, only one lead has a role in that opportunity, and over 50 interactions were needed to close the opportunity.

In one embodiment, a user interface may be provided by the marketing management system 100 to select between different interaction scoring models, such as accumulated interactions, weighted interactions, and interactions analyzed by a lead scoring algorithm. In addition, another user interface may be provided to plot the graph using bar charts to represent the determined interaction score. Other types of graphs and charts may also be used in plotting the activity points onto a graph. In one embodiment, the top twenty-five (25) leads are shown in the leads user interface 508 based on number of interactions. In other embodiments, a predefined number may be chosen by the marketing management system 100 based on the number of total leads associated with the account. Other filtering options may be provided to a viewer, such as showing a customizable number of leads, such as the top ten (10) leads, filtering types of interactions, and choosing a combination of filters.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for providing marketing analytics on a marketing management system, the method comprising:
receiving an indication that an opportunity has been created with a lead for an account in the marketing management system;
receiving one or more interactions associated with the lead, where the one or more interactions comprise one or more sales or marketing interactions and each interaction having a date;
determining a plurality of activity points corresponding to the received one or more interactions and the opportunity in the marketing management system, where each activity point corresponds to a predetermined date range and at least one of the one or more interactions based on the predetermined date range;
plotting the plurality of activity points on a graph based on the plurality of predetermined date ranges and a plurality of cumulative totals of the at least one of the one or more interactions for each activity point; and
providing the plotted graph for display to a user of the marketing management system.

2. The method of claim 1, wherein receiving an indication that an opportunity has been created with a lead for an account in the marketing management system further comprises:
receiving from an external sales platform information about creation of the opportunity with the lead for the account; and
associating the opportunity to the account.

3. The method of claim 1, wherein receiving an indication that an opportunity has been created with a lead for an account in the marketing management system further comprises:
receiving from a user interface on the marketing management system information about creation of the opportunity with the lead for the account; and
associating the opportunity to the account.

4. The method of claim 1, wherein receiving an indication that an opportunity has been created with a lead for an account in the marketing management system further comprises:
receiving from an external company system information about creation of the opportunity with the lead for the account; and
associating the opportunity to the account.

5. The method of claim 1, wherein each of the one or more marketing interactions includes a type of interaction.

6. The method of claim 1, wherein each of the one or more marketing interactions includes a textual description of interaction.

7. The method of claim 1, further comprising:
providing a filter selection user interface comprising a plurality of selectable filters for filtering the one or more interactions associated with the opportunity;
receiving a selection of a filter of the plurality of selectable filters in the filter selection user interface;
responsive to the selection of the filter, generating a subset of the one or more interactions associated with the opportunity based on the selection of the filter;
determining a subset of the plurality of activity points corresponding to the generated subset of the one or more interactions; and
plotting the subset of the plurality of activity points on the graph based on the predetermined date ranges and cumulative totals of the at least one of the one or more interactions for each activity point in the subset of the plurality of activity points.

8. The method of claim 7, wherein the selection of the filter comprises a lead.

9. The method of claim 7, wherein the selection of the filter comprises a type of interaction.

10. A method for analyzing interactions in relation to a sales opportunity, the method comprising:
receiving a plurality of interactions associated with a first set of leads, where each interaction includes a date and where the first set of leads are associated with a sales opportunity for an account in a marketing management system;
determining a first set of activity points, each activity point having a predetermined date period based on the plurality of interactions associated with the first set of leads;
plotting the first set of activity points chronologically on a timeline, where each activity point is plotted on the timeline based on a cumulative total of interactions for the predetermined date period of the activity point; and
providing the timeline in a user interface comprising the plotted one or more activity points for display to a user of the marketing management system.

11. The method of claim 10, wherein each interaction includes a type of the interaction, the method further comprising:
for each of the plurality of interactions, generating an interaction score based on the type of the interaction; and
plotting the one or more activity points on the timeline based on a cumulative total of the interaction scores for the plurality of interactions.

12. The method of claim 10, wherein determining the first set of activity points further comprises:
determining a weighted average of the plurality of interactions.

13. The method of claim 10, wherein determining the first set of activity points further comprises:
retrieving an advanced lead scoring algorithm;
for each of the plurality of interactions, generating an interaction score using the retrieved advanced lead scoring algorithm; and
plotting the one or more activity points on the timeline based on the interaction scores for the plurality of interactions.

14. The method of claim 10, further comprising:
selecting a new date period for the timeline; and
dynamically rendering the plotted one or more activity points on the timeline in the user interface for display to the user based on the new date period.

15. The method of claim 10, wherein plotting the one or more activity points chronologically on a timeline further comprises:
generating at least one line between the one or more activity points on the timeline;
generating a first vertical line from an activity point associated with an interaction indicating a creation of the opportunity to the timeline;
generating a second vertical line from an activity point associated with an interaction indicating a closing of the opportunity to the timeline; and
shading an area between the first and second vertical lines, the at least one line between the one or more activity points on the timeline, and the timeline.

16. The method of claim 15, wherein generating at least one line between the one or more activity points on the timeline further comprises generating a plurality of lines between consecutive activity points on the timeline in chronological order, the method further comprising:
identifying a line of the plurality of lines indicating to the user of the marketing management system a significant impact on the opportunity based on a slope of the line.

17. The method of claim 10, wherein plotting the one or more activity points chronologically on a timeline further comprises:
generating one or more selectable icons in the user interface for the one or more activity points;
receiving a selection of an icon of the one or more selectable icons; and
providing interaction detail information about an activity point corresponding to the selected icon in the user interface.

18. The method of claim 10, wherein plotting the one or more activity points chronologically on a timeline further comprises:
generating one or more icons of different sizes in the user interface for the one or more activity points, where a size of an icon is based on a cumulative total of interactions for the predetermined date period of the activity point associated with the icon.

19. The method of claim 10, further comprising:
providing the first set of leads associated with the sales opportunity and a second set of leads associated with the account as a plurality of selectable links in the user interface for display to the user of the marketing management system;
receiving a selection of a link in the user interface corresponding to a selected lead of the first and second sets of leads;
determining a second set of activity points, each activity point having a predetermined date period, based on the plurality of interactions associated with the first set of leads and the selected lead; and
dynamically rendering the second set of activity points on the timeline in the user interface for display to the user.

20. A method for providing interactions associated with sales opportunities in a marketing management system, the method comprising:
providing a graphical user interface for providing a plurality of interactions associated with an opportunity in the marketing management system on a graph having an x-axis of time periods and a y-axis of cumulative interactions, where the plurality of interactions are provided as a first set of activity points having time periods corresponding to the x-axis and cumulative interactions corresponding to the y-axis;
providing a plurality of selectable links in the graphical user interface for selecting one or more leads to be associated with the opportunity, where the one or more leads are associated with a plurality of interactions;
receiving a selection of a link to associate a lead with the opportunity, the lead associated with a new set of interactions;
combining the new set of interactions with the plurality of interactions associated with the opportunity; and
providing for display in the graphical user interface the combined interactions comprising the plurality of interactions associated with the opportunity and the new set of interactions associated with the selected lead, where the combined interactions are provided as a second set of activity points having time periods corresponding to the x-axis and cumulative interactions corresponding to the y-axis.

21. The method of claim 20, wherein the graphical user interface comprises an application operating on a user device associated with a user of the marketing management system and wherein the selection of the link is received through an application programming interface (API) call from the user device.

22. The method of claim 20, wherein the graphical user interface comprises a web page loaded on a browser operating on a user device associated with a user of the marketing management system and wherein the selection of the link is received through a web page browser instruction from the user device.

23. A computer program product comprising a computer-readable storage medium containing computer program code for executing instructions to perform a method of providing marketing analytics on a marketing management system, the method comprising:
receiving an indication that an opportunity has been created with a lead for an account in the marketing management system;
receiving one or more interactions associated with the lead, each interaction having a date and where the one or more interactions comprise one or more sales or marketing interactions;
generating a plurality of associations between the one or more marketing interactions, the one or more sales interactions, and the opportunity in the marketing management system;
determining a plurality of activity points corresponding to the plurality of associations between the one or more interactions and the opportunity in the marketing management system, where each activity point corresponds to a predetermined date range and at least one of the interactions based on the predetermined date range;
plotting the plurality of activity points on a graph based on the predetermined date ranges and cumulative totals of the plurality of associations for each activity point; and
providing the plotted graph for display to a user of the marketing management system.

24. A computer program product comprising a computer-readable storage medium containing computer program code for executing instructions to perform a method for analyzing interactions in relation to a sales opportunity, the method comprising:
receiving a plurality of interactions associated with a first set of leads, where each interaction includes a date and where the first set of leads are associated with a sales opportunity for an account in a marketing management system;
determining a first set of activity points, each activity point having a predetermined date period based on the plurality of interactions associated with the first set of leads;
plotting the first set of activity points chronologically on a timeline, where each activity point is plotted on the timeline based on a cumulative total of interactions for the predetermined date period of the activity point; and
providing the timeline in a user interface comprising the plotted one or more activity points for display to a user of the marketing management system.

25. A computer program product comprising a computer-readable storage medium containing computer program code for executing instructions to perform a method for providing interactions associated with sales opportunities in a marketing management system, the method comprising:
providing a graphical user interface for providing a plurality of interactions associated with an opportunity in the marketing management system on a graph having an x-axis of time periods and a y-axis of cumulative interactions, where the plurality of interactions are provided as a first set of activity points having time periods corresponding to the x-axis and cumulative interactions corresponding to the y-axis;
providing a plurality of selectable links in the graphical user interface for selecting one or more leads to be associated with the opportunity, where the one or more leads are associated with a plurality of interactions;
receiving a selection of a link to associate a lead with the opportunity, the lead associated with a new set of interactions;
combining the new set of interactions with the plurality of interactions associated with the opportunity; and
providing for display in the graphical user interface the combined interactions comprising the plurality of interactions associated with the opportunity and the new set of interactions associated with the selected lead, where the combined interactions are provided as a second set of activity points having time periods corresponding to the x-axis and cumulative interactions corresponding to the y-axis.
